(19) United States
(12) Patent Application Publication
(10) Pub. No.: US 2009/0227405 A1
(43) Pub. Date: Sep. 10, 2009

(54) Automatic adjustable apparatus

(75) Inventor: Cheng Feng Lin, Taipei City (TW)

Correspondence Address: BACON & THOMAS, PLLC, 625 SLATERS LANE, FOURTH FLOOR, ALEXANDRIA, VA, 22314-1176, US

(73) Assignee: UNIPOINT ELECTRIC MFG. CO., LTD., Taipei City (TW)

(21) Appl. No.: 12/073,602

(22) Filed: Mar. 7, 2008

(51) Int. Cl. F16H 7/08

(52) U.S. Cl. 474/112

(57) ABSTRACT

An automatic adjustment apparatus comprises a pulley having a spindle hole, an one-way bearing disposed in the spindle hole, a two-way bearing disposed in the spindle hole and located at a side of the one-way bearing, a sleeve and at least one constraint component. The sleeve is disposed in the one-way bearing and the two-way bearing, and a constraint portion is concaved at a side of the sleeve. The constraint component is mounted on the constraint portion for constraining the displacement of the pulley moving at the axial direction of the sleeve. Therefore, the pulley can glide at the sleeve so as to prevent inclination of the installing position of a belt at the pulley which results in rapid abrasion in belt and bad driving safety.

### FIELD OF THE INVENTION

The present invention relates to an automatic adjustable apparatus, and more particularly to an automatic adjustable apparatus capable of automatically adjusting the position of the pulley of the alternator of the car.

### BACKGROUND OF THE INVENTION

In the vehicle alternator system, the alternator can generate and reserve the electric power for the usage of electrical parts within the vehicle through a running engine, and a transmission mechanism in such system is constructed by using the pulley and the belt between the engine and the alternator. FIG. 1 and 2 illustrates an exploded view and a sectional view of the one-way gearing wheel of the alternator system in prior art respectively. The one-way gearing wheel comprises a pulley 1, a one-way bearing 21, a ball bearing 22, a sleeve 23 and a washer ring 24. The pulley 1 has a step spindle hole 11 at the center, both the one-way bearing 21 and the bearing 22 are wedged in the step spindle hole 11, and the sleeve 23 is disposed through the one-way bearing 21 and the ball bearing 22, meanwhile, a rotor shaft connecting portion 231 which connects a rotor 25 of the alternator (not shown) is equipped at the center of sleeve 23. When the alternator of vehicle is driven to create the electrical power, the one-way bearing 21, ball bearing 22 and sleeve 23 are driven to rotate via a multiple groove belt 26 mounted on pulley 1, so as to drive the rotor 25 rotating for generation of the electrical power. Since the relative position of the pulley 1 towards sleeve 23 is fixed in the conventional one-way gearing wheel, which restricts the sliding displacement along the axial direction of the sleeve 23, hence, the multiple groove belt 26 will be compressed to squeeze the pulley 1 to slant while external force is applied thereon, this results in rapid wearing and breakdown of multiple belt 26, and further increases the danger in driving a vehicle.

To overcome the foregoing drawbacks, the inventor(s) of the present invention based on years of experience in the related field to conduct extensive researches and experiments, and finally invented an automatic adjustable apparatus as a basis for resolving the foregoing drawback.

### SUMMARY OF THE INVENTION

Therefore, it is one of objectives of the present invention to provide an automatic adjustable apparatus capable of automatically adjusting the position of the pulley.

In an aspect, the present invention provides an automatic adjustable apparatus comprising a pulley, a one-way bearing, a two-way bearing, a sleeve and a constraint component. The pulley has a spindle hole at the center and the one-way bearing is disposed in the spindle hole, and the two-way bearing is disposed in the spindle hole and located at one side of the one-way bearing. The sleeve has an axial direction and slidably disposed in one-way bearing and two-way bearing to enable the pulley sliding along at said axial direction, and a constraint portion is disposed on the sleeve. The constraint component is mounted on the constraint portion for constraining the displacement of the pulley at the axial direction of the sleeve.

In another aspect, the present invention provides an automatic adjustable apparatus comprising a pulley, a one-way bearing, two two-way bearings, a sleeve and two constraint components. The pulley has a spindle hole located in the center thereof in which the one-way bearing and the two-way bearings are placed, and each one of the two-way bearings is adjacently placed to the one-way bearing respectively. The sleeve has an axial direction and two constraint portions disposed at two side of said sleeve respectively. The sleeve is disposed slidably in one-way bearing and the two-way bearings for enabling the pulley to slide along at the axial direction. The constraint components are mounted on the constraint portions respectively for constraining the displacement of the pulley at the axial direction of the sleeve. As described above, followed by the automatic adjustable apparatus in accordance with the present invention, the pulley can move slidably along the axial direction of the sleeve, so the belt disposed on the pulley will not be compressed to squeeze the pulley while external force is applied thereon. This can prevent rapid wearing and breakdown of belt.

### BRIEF DESCRIPTION OF THE DRAWINGS

The subject matter regarded as the invention is particularly pointed out and distinctly claimed in the concluding portion of the specification. The invention, both as to system and method of operation, together with features and advantages thereof may best be understood by reference to the following detailed description with the accompanying drawings in which:

FIG. 1 illustrates an exploded view of the one-way gearing wheel in accordance with the prior art;

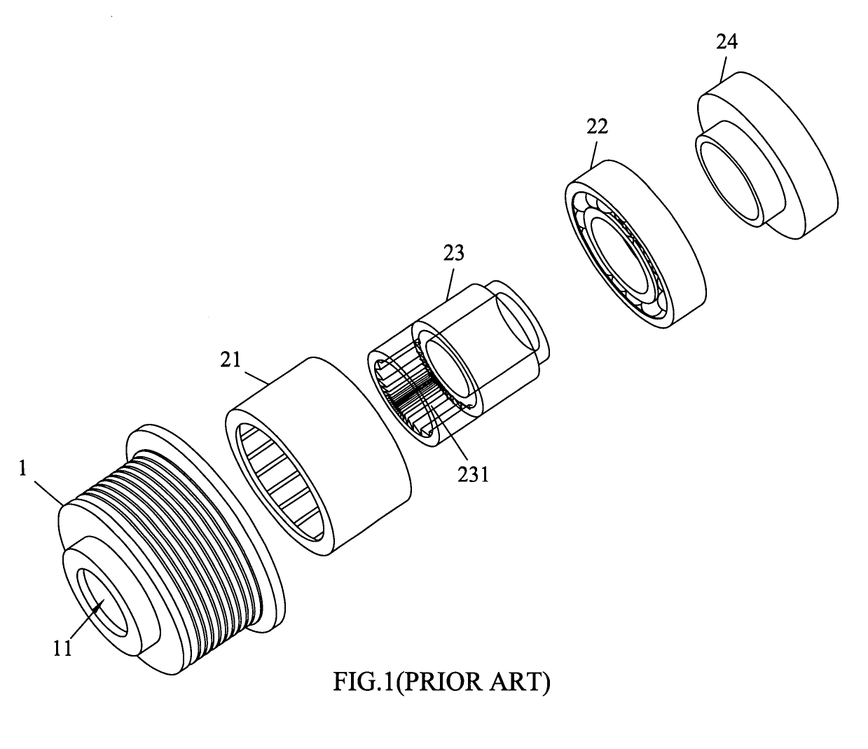

FIG. 2 illustrates a sectional view of the one-way gearing wheel in accordance with prior art;

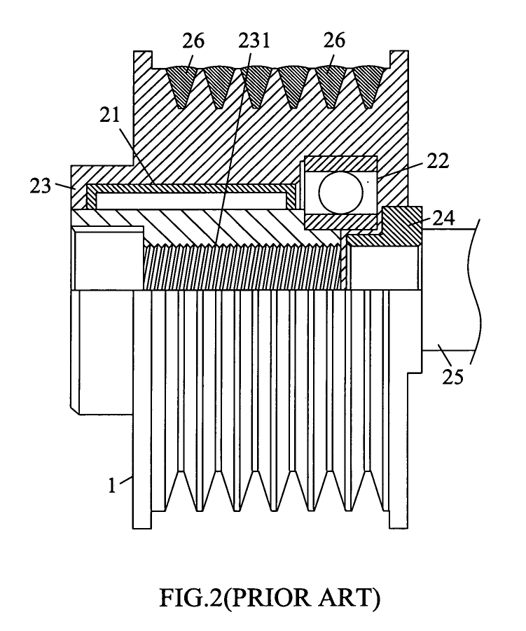

FIG. 3 illustrates an exploded view of the embodiment of the automatic adjustable apparatus in accordance with the present invention;

FIG. 4 illustrates a sectional view of the embodiment of the automatic adjustable apparatus in accordance with the present invention while the pulley remains in original position without being compressed by the belt.

FIG. 5 illustrate a sectional view of the embodiment of the automatic adjustable apparatus in accordance with the present invention, while the pulley is compressed by the belt to move along the first direction and limited by the snap ring; and

FIG. 6 illustrates a sectional view of the embodiment of the automatic adjustable apparatus in accordance with the present invention, while the pulley is compressed by the belt to move along the second direction and limited by the snap ring.

### DETAILED DESCRIPTION OF THE PREFERRED EMBODIMENTS

To make it easier for our examiner to understand the present invention, the following detailed description with reference to the accompanying drawings of embodiments are given for example, but such preferred embodiment is not intend to limit the scope of the present invention. For simplicity, like numerals are used for like elements as described in the specification of the present invention.

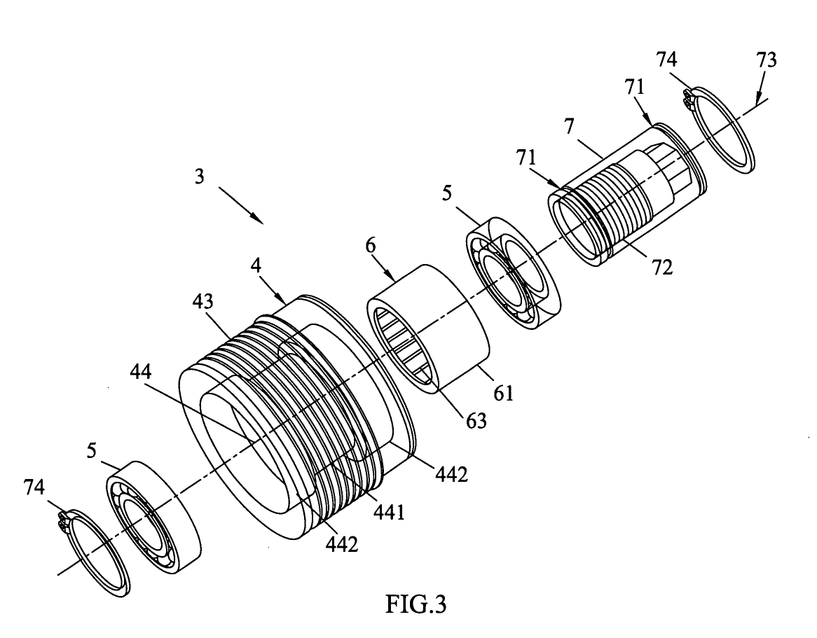

FIG. 3 illustrates an exploded view of the embodiment of the automatic adjustable apparatus in accordance with the present invention. The automatic adjustable apparatus comprises a pulley 4, two two-way bearings, a one-way bearing, a sleeve 7 and two constraint components. In this embodiment, the one-way bearing is implemented by a one-way needle bearing 6, the two-way bearing is implemented by the ball bearing 5, and the constraint component is implemented by a snap ring 74. Preferably, the two-way bearing also can be selected from a group including a self lubricating bearing, a thrust cone ball bearing, a thrust ball bearing, a two-way needle bearing, and the bearing which can sustain the two-way axial loading.

The pulley 4 has a step spindle hole 44 at the center which has an one-way bearing section 441 and two two-way bearing section 442 located at two side of the one-way bearing 441, and the one-way needle bearing 6 and the ball bearings 5 are disposed in the one-way bearing section 441 and two two-way bearing sections 442 respectively. A plural V shape belt grooves 43 are disposed at the outer surface of wall of the pulley 4.

The one-way needle bearing 6 has an outer surface of the wall 61 which contacts against the one-way bearing section 441 tightly for preventing the pulley 4 and the ball bearings 5 from occurring relative displacement with each other. The inner side of the one-way needle bearing 6 is disposed plural one-way needle rollers 63 for driving the one-way needle bearing 6 to rotate clockwise only. While the one-way needle roller 63 is rotated counterclockwise, the one-way needle roller 63 will be in a running idle state and can not drive the one-way needle bearing 61 to rotate counterclockwise. The ball bearings 5 are tightly disposed in the corresponding two-way bearing section 42 respectively for preventing the relative displacement between the pulley 4 and the ball bearing.

The sleeve 7 has an axial direction 73, and is formed a shape of hollow cylinder and slidably disposed in the one-way needle bearing 6 and ball bearings 5, so that the pulley 4 can slidably move back and forth along the axial direction 73. The one side of the sleeve 7 is formed a rotor shaft connecting portion 72 having a shape of tapped hole, and the other side is formed a hexagonal hole as a grabbing portion for assembly (not shown). The constraint portions 71 are further disposed at two side of the outer surface of the sleeve 7 respectively. Each of the constraint portions 71 is the shape of circular constraint groove, which are concaved from the outer surface of the sleeve 7 towards the axis of the sleeve 7. The distance between two constraint portions 71 is larger than the distance between the inner radiuses of the two ball bearings 5 which are disposed in the two-way bearing sections 442.

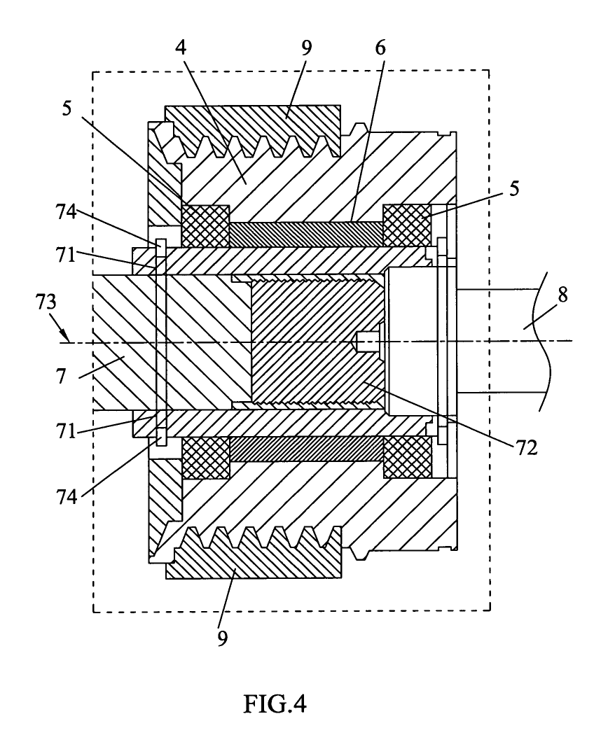

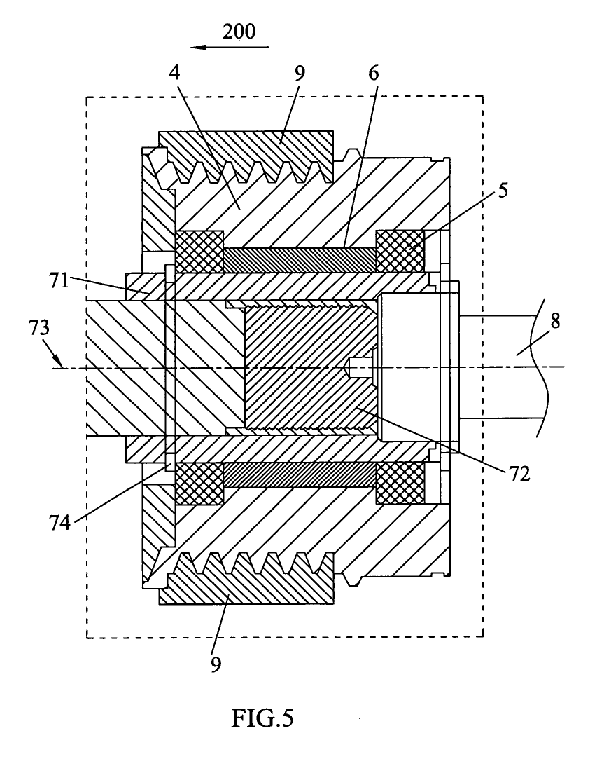

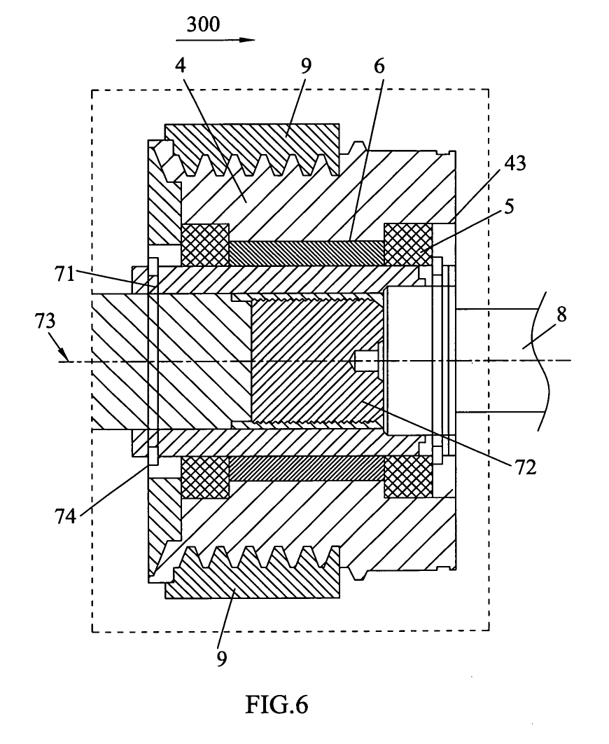

FIG. 4, FIG. 5 and FIG. 6 illustrate the sectional view of the embodiment of the embodiment of the automatic adjustable apparatus in accordance with the present invention while the pulley is at different location respectively. After the sleeve 7 is disposed in the spindle hole 44 of the one-way needle bearing 6 and the ball bearing 5, the two snap rings 74 are then mounted tightly on corresponding constraint portions 71. The radius of the snap ring 74 is larger than the inner radius of ball bearings 5, and the distance between the two constraint portions 71 is larger than the distance between two ball bearings 5 disposed in the pulley 4, so the snap rings 74 can contact against one of the ball bearing 5 and limit the displacement range of the pulley 4 while pulley 4 moves along the axial direction 73 of the sleeve 7. Therefore, the pulley 4 is only able to move back and forth between two constraint portions 7 land this can prevent the pulley 4 disengaging from sleeve 7.

For generating electricity by using the alternator, the rotor 8 of the alternator is connected with the rotor shaft connecting portion 72, and the belt 9 disposed on the belt groove 43 is used for driving the pulley 4 to rotate clockwise. The rotation of the pulley 4 further drives the one-way needle 6, the sleeve 7, the rotor shaft connecting portion 72, and the rotor 8 to rotate synchronously, so as to cause the alternator generate electricity. While the pulley 4 rotates, only the outer ring of ball bearing 5 is rotated by the pulley 4, the inner ring of ball bearing 5 will not be rotate by the pulley 4, so that the ball bearing 5 can improve the axial loading and thrusting loading of the pulley 4.

While receiving an external force parallel to axial direction 73, the belt 9 will compress the pulley 4 which then is forced to glide towards the first direction 200 or the second direction 300, and the compressing pressure received by the belt 9 can be released, this can prevent the belt 9 becoming deformation or separating from belt groove 43, and the rapid abrasion and breakdown of the belt 9 due to abnormal operating location will not occurred. While the pulley 4 glides towards the first direction 200 or the second direction 300, the ball bearing 5 will contacts against the snap ring 74 and its displacement range is limited by the snap ring 74, this can prevent over-displacement of the pulley 4, and further prevent the pulley 4 from disengaging from the automatic adjustable apparatus 3.

By using the snap ring 74 and the constraint portion 71, the pulley 4 can glide in a predefined displacement range while being compressed by the pulley 9, and the relative position between the belt 9 and the pulley 4 can be hold, this can prevents over abrasion of the belt 9 due to deviation from original disposed position while belt 9 compresses the pulley 4 at high speed. The designer can determine the distance between two constraints portions 71 based on width of the belt 9 or rotation speed of the pulley 4, so the goal of present invention can be achieved.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An automatic adjustable apparatus, comprising
a pulley, having a spindle hole at the center;
an one-way bearing, disposed in said spindle hole;
a two-way bearing, disposed in said spindle hole and located at one side of said one way bearing;
a sleeve, having an axial direction and a constraint portion, disposed slidably in said one way bearing and said two way bearing to enable said pulley sliding along at said axial direction, and said constraint portion mounted on said sleeve; and
a constraint component, mounted on said constraint portion, for constraining the displacement of said pulley at said axial direction.

2. The automatic adjustable apparatus of claim 1, wherein said constraint portion is a constraint groove concaved circularly at said sleeve.

3. The automatic adjustable apparatus of claim 1, wherein said constraint component is a snap ring.

4. The automatic adjustable apparatus of claim 1, wherein said sleeve has a rotor shaft connecting portion at the inner side, and said rotor shaft connecting portion is for connecting to a rotor.

5. The automatic adjustable apparatus of claim 4, wherein said rotor shaft connecting portion is formed a shape of tapped hole to thread said rotor.

6. The automatic adjustable apparatus of claim 1, wherein said two way bearing is selected a group including a ball bearing, a self lubricating bearing, a thrust cone ball bearing, a two way needle bearing, and a thrust ball bearing.

7. The automatic adjustable apparatus of claim 3, wherein said snap ring is for contacting against said two way bearing and constraining the displacement of said pulley at said axial direction while said pulley moves along at said axial direction.

8. An automatic adjustable apparatus, comprising
a pulley, having a spindle hole at the center;
an one-way bearing, disposed in said spindle hole;
two two-way bearings, disposed in said spindle hole and located at two side of said one way bearing respectively;
a sleeve, having an axial direction and two constraint portions, said sleeve disposed slidably in said one way bearing and said two way bearings for enabling said pulley to slide along at said axial direction, and said constraint portions disposed at two side of said sleeve respectively; and
two constraint components, mounted on said constraint portions respectively, for constraining the displacement of said pulley at said axial direction.

9. The automatic adjustable apparatus of claim 8, wherein said constraint portion is a constraint groove concaved circularly at said sleeve.

10. The automatic adjustable apparatus of claim 8, wherein said constraint component is a snap ring.

11. The automatic adjustable apparatus of claim 8, wherein said sleeve has a rotor shaft connecting portion at the inner side, and said rotor shaft connecting portion is for connecting to a rotor.

12. The automatic adjustable apparatus of claim 11, wherein said rotor shaft connecting portion is formed a shape of tapped hole to thread said rotor.

13. The automatic adjustable apparatus of claim 8, wherein said two-way bearing is selected from a group including a ball bearing, a self lubricating bearing, a thrust cone ball bearing, a two way needle bearing and a thrust ball bearing.

14. The automatic adjustable apparatus of claim 10, wherein said snap ring is for contacting against said two way bearing and constraining the displacement of said pulley at said axial direction while said pulley moves along at said axial direction.
